(19) United States
(12) Patent Application Publication
(10) Pub. No.: US 2009/0095732 A1
(43) Pub. Date: Apr. 16, 2009

(54) Multi-Functional Cooker

(76) Inventor: Kuochu Li, Yonkang (TW)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(21) Appl. No.: 12/338,964

(22) Filed: Dec. 18, 2008

(30) Foreign Application Priority Data
May 8, 2007 (CN) 200720007016.0

(51) Int. Cl. F27D 11/00; H05B 1/02

(52) U.S. Cl. 219/441; 219/494

(57) ABSTRACT

A multi-functional cooker disclosed in the present invention at least comprises a base on which a pan body, a power line, a first heating unit, a second heating unit and a control panel are mounted. The first heating unit comprises a heating body, a first control circuit and a first control switch. A first loop is formed by the power line, the heating body, the first control circuit and the first control switch. The second heating unit comprises a band heater, a second control circuit and a second control switch. A second loop is formed by the power line, the band heater, the second control circuit and the second control switch. The first and second heating units have independent control circuits respectively, each control circuit can be adjusted to the optimal cooking state according to the different cooking functions performed by the heating units, so the present multi-functional cooker not only can perform the multiple functions such as steaming, frying, stir-frying, deep-frying and stewing etc. but also every functions can be performed to the optimal cooking effect.

### FIELD OF THE INVENTION

The present invention relates to multi-functional cookers.

### PRIOR ART

The earlier cookers are only with single-function, which is a stewing function. According to this defect, the present inventor has provided an improved scheme with the title as “multi-functional cooker” which has been disclosed in the database of SIPO with the publication number of CN2728355Y. The multi-functional cooker comprises a panel, a base, an outer pan, an inner pan and a cover, herein the base has a control circuit inside, the panel with a switch connecting to the control circuit inside, and a functional select knob and a step select knob mounted on the panel. The outer pan is hanged on the body and fixed on the base, and a heating body connecting with the circuit arranged in the bottom of the outer pan and a multi-functional band heater surrounded the outer pan. The inner pan is sheathed within the outer pan, and the cover is covered on the inner pan. The users can select the heating body or the band heater to heat up via switch. When the heating body is heating up, the functions of steaming, frying, stir-frying, deep-frying will be performed. When the band heater is heating up, the function of stewing will be performed. Although this improved scheme can perform the functions of steaming, frying, stir-frying, deep-frying and stewing etc. according to the need of the user, the function control circuit, step select knob and the temperature controller can not be operated optimally to meet the need of the different functions because the heating body and the band heater are using the same control circuit, step select knob and the temperature controller. Therefore, the heating body and the band heater can not perform the optimal effect in cooking.

### SUMMARY OF THE INVENTION

The multi-functional cooker provided in the present invention can obviate the disadvantages and limitations of the prior multi-functional cooker whose heating body and band heater can not perform the optimal cooking effect.

The objects of the invention are achieved by providing a multi-functional cooker at least comprising a base on which a pan body, a power line, a first heating unit, a second heating unit and a control panel are mounted. The pan body is equiped with a cover. The first heating unit comprises a heating body, a first control circuit and a first control switch, and the power line, and the heating body, the first control circuit and the first control switch are forming a first loop. The second heating unit comprises a band heater, a second control circuit and a second control switch, and the power line, the band heater, the second control circuit and the second control switch are forming a second loop. Both the first and second control switches are mounted on the control panel for users to select the first or second heating unit to heat the pan body.

According to one preferred embodiment of the present invention, the first heating unit further comprises a temperature controller connected to the first circuit.

According to one preferred embodiment of the present invention, the second heating unit further comprises a power-switchable multi-step switch connected to the second circuit.

According to one preferred embodiment of the present invention, the first heating unit further comprises a first temperature controller connected to the first circuit.

According to one preferred embodiment of the present invention, the second heating unit further comprises a second temperature controller connected to the second circuit.

According to one preferred embodiment of the present invention, the first heating unit further comprises a first temperature controller connected to the first circuit; the second heating unit further comprising a second temperature controller connected to the second circuit; and both the first and second temperature controllers are arranged on the control panel.

According to one preferred embodiment of the present invention, the first and second control switches are integrated into a three pole switch.

The multi-functional cooker of the present invention, wherein the first and second heating units have independent control circuits respectively, the two control circuits can be adjusted to the optimal cooking state according to the different cooking functions performed by the heating units, thus the multi-functional cooker not only can perform the multiple functions such as steaming, frying, stir-frying, deep-frying and stewing, etc., but also every function can be performed to the optimal cooking effect.

### BRIEF DESCRIPTION OF THE DRAWING

Preferred embodiment of the present invention will be described in detail with reference to the drawings and examples.

FIG. 1 is an exploded view of the multi-functional cooker of the present invention.

FIG. 2 is an exploded view of the heating unit of the multi-functional cooker of the present invention, wherein the broken line indicated the circuit connections.

FIG. 3 is a schematic view of the circuit of the multi-functional cooker of the present invention.

### DETAILED DESCRIPTION OF THE INVENTION

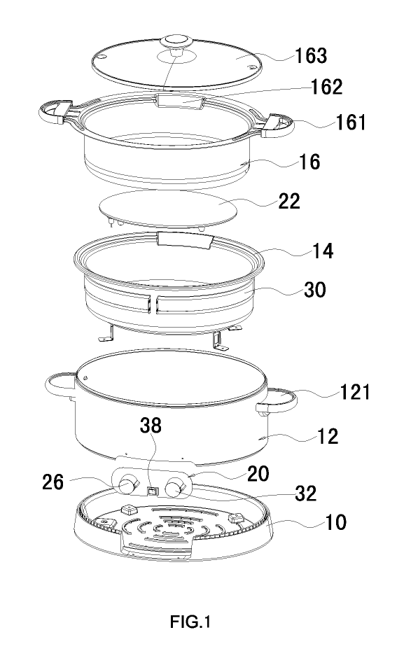

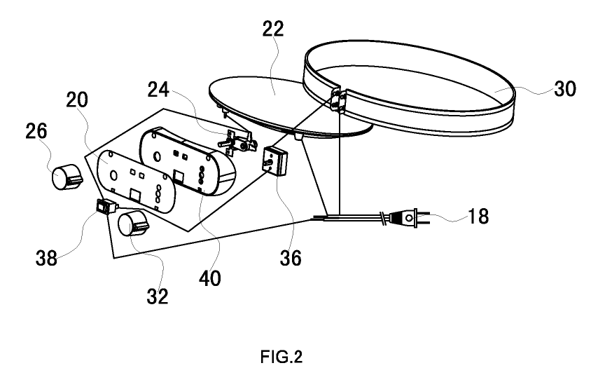

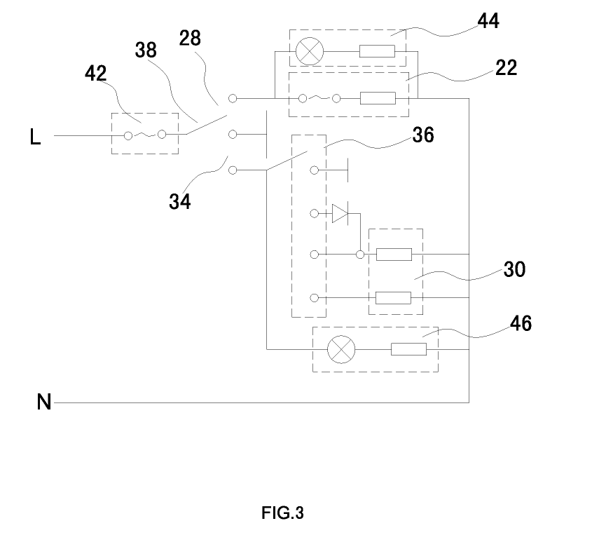

Referring to FIG. 1, FIG. 2 and FIG. 3, FIG. 1 is an exploded view of the multi-functional cooker, FIG. 2 is an exploded view of the heating unit of the multi-functional cooker of the present invention, FIG. 3 is a schematic view of the circuit of the multi-functional cooker of the present invention. The multi-functional cooker of the present invention comprises a base on which a pan body 16, a power line 18, a first heating unit, a second heating unit and a control panel 20 are mounted. The base comprises a bottom 10, a body 12 and an outer pan 14, herein the body 12 is an annular shell fixed on the bottom 10, the outer pan 14 is sheathed within the body 12 and fixed on the bottom 10, and both sides of the body 12 have a handle 121.

The first heating unit comprises a heating plate 22, a first control circuit, a thermostat 24, a first temperature controller 26 and a first control switch 28, herein the power line 18, the heating plate 22, the first control circuit, the thermostat 24, the first temperature controller 26 and the first control switch 28 form a first loop to perform the function of steaming, stir-frying, frying, deep frying etc. on high power. A first indicator light circuit 44 is preferably arranged in the first loop for the needs. The second heating unit comprises a band heater 30, a second control circuit, a four-step switch 36, a second temperature controller 32 and a second control switch 34. The power line 18, band heater 30, the four-step switch 36, the second control circuit and the second control switch form a second loop to perform the four functions of slow-stewing, middle-stewing, fast-stewing and rapid-stewing on lower power. Mostly, a second indicator light circuit 46 is preferably arranged in the second loop for the needs. And there is a fuse 42 disposed in the power line 18 for the need.

The heating plate 22 is set on the bottom of the outer pan 14, and the band heater 30 is surrounded on the outside of the outer pan 14. The control panel 20 is fixed on the body 12. The control panel 20 comprises a panel plate and a connection receptacle 40, and the connection receptacle 40 is fixed on the back of the panel. Above-mentioned first control circuit, temperature controller 24, second control circuit and four-step switch 36 are connecting to the connection receptacle 40 of the control panel 20 respectively. Above-mentioned first control switch 28 and second control switch 34 are integrated into a three-pole switch 38 which is set on the front of the panel plate. If the left side of the three-pole 38 switch is pressed, the first control switch 28 will be linked. If the right side of the three-pole switch 38 is pressed, the second control switch 34 will be linked. When the three-pole switch 38 return to the middle, the electrical source will be cut off. Above-mentioned first temperature controller 26 and the second temperature controller 32 are mounted on the left and right side of the three-pole switch 38 respectively.

Pan body 16 is sheathed within the outer pan 14, and a cover 163 is mounted correspondingly on the pan body 16. Each of the two sides of the pan body 16 has a handle 161, and one side of the body 16 has a pouring open 162.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with detailed description, but rather by the claims appended hereto.

What is claimed is:

1. A multi-functional cooker, comprising:
a base;
a pan body with a corresponding cover disposed on said base;
a power line;
a first heating unit used for heating up said pan body comprising a heating body, a first control circuit and a first control switch, and said power line, said heating body, said first control circuit and said first control switch forming a first loop;
a second heating unit used for heating up said pan body comprising a band heater, a second control circuit and a second control switch, and said power line, said band heater, said second control circuit and said second control switch forming a second loop; and
a control panel on which said first control switch and said second control switch are mounted.

2. The multi-functional cooker according to claim 1, wherein said first heating unit further comprises a thermostat connected to said first loop.

3. The multi-functional cooker according to claim 1, wherein said second heating unit further comprises a power-switchable multi-step switch connected to said second loop.

4. The multi-functional cooker according to claim 1, wherein said first heating unit further comprises a first temperature controller connected to said first loop.

5. The multi-functional cooker according to claim 1, wherein said second heating unit further comprises a second temperature controller connected to said second loop.

6. The multi-functional cooker according to claim 1, wherein said first heating unit further comprises a first temperature controller connected to said first loop; said second heating unit further comprises a second temperature controller connected to said second loop; both said first temperature controller and said second temperature controller are arranged on said control panel.

7. The multi-functional cooker according to claim 1, wherein said first control switch and said second control switch are integrated into a three pole switch.
